(19) United States
(12) Patent Application Publication
(10) Pub. No.: US 2020/0366871 A1
(43) Pub. Date: Nov. 19, 2020

(54) All Weather Camera System and Methods for Control Thereof

(71) Applicant: EarthCam, Inc., Upper Saddle River, NJ (US)

(72) Inventors: Brian Cury, Alpine, NJ (US); James B. Nicoll, Livingston, NJ (US)

(73) Assignee: EarthCam, Inc.

(21) Appl. No.: 16/987,228

(22) Filed: Aug. 6, 2020

Related U.S. Application Data
(63) Continuation of application No. 14/196,599, filed on Mar. 4, 2014, now abandoned.

(51) Int. Cl. H04N 7/18; H04N 17/00; H04N 5/232; G03B 17/08; G03B 17/56

(52) U.S. Cl. CPC H04N 7/183; H04N 17/002; G03B 17/561; G03B 17/08; H04N 5/23238

(57) ABSTRACT

An all-weather, remote camera system includes a weather-proof camera housing and other components, such as a network connection, that allows the system to be placed in locations for capturing images over periods of time. The camera system includes a megapixel camera linked to a device server and image storage device to capture images under a variety of conditions. The camera system also includes a zoom capability to generate panoramic images. The zoom operations are performed within the camera system at its location, by moving the camera body while the camera lens remains in a fixed position relative to the camera housing.

### PRIORITY

This application claims domestic benefit as a continuation from pending application Ser. No. 14/196,599, filed Mar. 4, 2014.

### FIELD OF INVENTION

The present invention relates to an all-weather camera system that monitors and provides digital images with limited manual control. More particularly, the present invention relates to an all-weather camera system and methods of controlling the camera system that provide video imaging and extremely high resolution composite imaging.

### BACKGROUND

Cameras are used to remotely monitor and archive images and video in a variety of situations. Many of these cameras may be set in a location to provide around the clock monitoring, and are not directly controlled by a person. Cameras may be fitted into environmentally controlled enclosures as to be suitable for outdoor use. Robotic pan/tilt/zoom mechanisms may be used to provide remote aiming of the camera systems. The images produced by these cameras also may not be appropriate or applicable to high definition archival applications. If these cameras become disconnected or offline from the network, then the archived data may be lost or not retrievable. Most cameras used for remote motoring are video-enabled cameras. Most available high resolution archival cameras produce single fixed-position images.

The best way to capture high-resolution images is in the use of digital single-lens reflex (DSLR) camera technology because of the sensor size, but, because the lens is manual, there is no important zoom functionality. Where a camera lens has a zoom function, that involves the lens extending or retracting from the camera body. Conventional cameras may include a gigapan capability, but these cameras are not suitable for outdoor or continuous use.

Special equipment and housing must be used to provide a panoramic capability with the high-resolution image capture. Such cameras are not “all-weather” or suitable for outdoor use. Further, they are not autonomous. An operator must be present, which is difficult for those locations that are remote, hazardous, or require an extended photographic term. For example, it would not be convenient or cost-effective to have an operator sit with such a camera on top of a tall building and provide daily photographs of a three year construction project. Further, if the camera system goes offline, then the data is lost.

The process of creating a gigapixel image involves stitching together multiple high-resolution images to produce one large high resolution image, which cannot be replicated by a camera with a wide angle lens that takes one wide shot. The camera not only needs to pan and tilt when it captures images, but it also needs to zoom in at small increments to take over hundreds (or more) closeups to be blended as layers of the gigapixel image. Thus, the lack of a remotely controlled zoom capability in the conventional cameras discussed above impedes the creation of such images at varying levels of resolution in an automated fashion without physically (manually) resetting the zoom level.

Where a camera lens is capable of zooming in and out with respect to the camera body, the extended lens presents a potential fragile part of the camera, with attendant risks from external factors, such as rain, wind, dust, or falling or wind-driven objects.

Prior art camera systems such as Choate, U.S. Pat. No. 5,523,583, are used as part of an optical inspection system for examining and viewing objects in a specific and close location. Choate discloses a camera moved with respect to a telecentric lens, and provides for the entire camera and lens arrangement to be moved toward or away from the target object for magnification of the target. Choate's telecentric lens does not allow for high resolution images of distant outdoor objects, and specifically teaches away from the use of a conventional lens, as would be used for viewing objects at a distance.

### SUMMARY

The claimed embodiments disclose an indoor/outdoor camera system having a tamper and impact resistant enclosure with an integrated camera and lens system. The camera and lens system are of a conventional type. The lens is fixed in position with respect to the enclosure, with an assembly to move the camera body relative to the lens. Unlike prior art camera systems, the lens remains in a fixed position, and the camera body is moved to allow for a zoom feature.

The disclosed camera system includes a zoom control assembly. This assembly moves along a track rail guide that is mounted to the system housing. This feature allows the camera system to incorporate a much larger lens for better zoom capability. The lens is fixed in place with respect to the enclosure, where the camera body is moved by the zoom control assembly to perform zoom operations. The disclosed system can change zoom levels on the fly so that the system can create one, two, five or ten gigapixel panorama images from the same setup. Thousands of images may be pieced together to create gigapixel images. An example may be taking a smaller resolution panoramic image once a day, a larger one once a week, and huge one once a month. This feature is enabled due to the variable zoom capability of the disclosed embodiments.

The all-weather, remote camera system also includes a conventional camera enclosed by a camera housing. The camera is configured to capture an image or live video. The camera system also includes a storage device to store the image or live video. The camera system also includes a device server configured to instruct the camera to capture the image or live video.

An all-weather, remote camera system also is disclosed. The camera system includes a camera housing engaged to a pan/tilt base and having an enclosure window. The camera system also includes a conventional megapixel camera enclosed by the camera housing. The camera is configured to capture an image or video. The camera system also includes a storage device to store the image or video. The camera system also includes a device server configured to instruct the camera to capture the image or video. The camera system also includes a zoom control assembly to move the camera while lens of the camera remains fixed with respect to the enclosure window of the camera housing. The zoom control assembly includes a track guide rail and a mount sled to move the camera. The enclosure window is preferably clear, and manufactured from optically clear glass, and may protect the camera system and its camera from the elements.

The camera system also features a heavy-duty robotic pedestal mounted on a fixed pole, wall, parapet, or a non-penetrating roof mount. The disclosed embodiments also include a platform for the camera and lens that provides these features. The disclosed camera system may take high-resolution 12, 16, 24, 32 or 64 megapixel digital images on a periodic basis (such as hourly, daily, weekly, or monthly) and also provide live video. For a panoramic image, the disclosed system captures a plurality of images in the correct sequence and uploads the images to servers over the connected network. A process or method may combine these high-resolution images with panorama stitching technology to create gigapixel images from the captured data.

The disclosed embodiments are not limited to these pixel counts, and include the appropriate high-resolution standards applicable to future camera systems. The disclosed system may incorporate other resolutions as well, and is not limited to these values.

The disclosed system uploads both still images and video over a wireless cellular modem, a wireless point-2-point system, or a hard wired connection to the Internet. The disclosed system also may provide a live stream of video on demand. The content is sent to a secure, password protected website or other IP-addressable location with an interface and online software features provided as a managed service. The disclosed system may take advantage of wireless communications technology to provide images and video to a remote network. The disclosed system may incorporate a mobile broadband service.

The disclosed system may operate within a range of 90-240 volt alternating current (AC) or 12 volt direct current (DC) and have a preferred power consumption of about 46 watts. The range of AC voltages allows the disclosed system to implement different input AC voltages. The disclosed system may also operate on solar power. The solar power may be collected and stored in a battery, or an array of batteries, coupled to the camera system.

The disclosed camera system provides live video, high definition images and multiple preset views in one package. The disclosed system may also include an optional washer and wiper system to keep the lens and lens window unobstructed under any conditions. The disclosed system also includes on-board backup data storage in the case of loss of connectivity. All of these features are provided on a platform that may be placed in most, if not all, locations.

Images and video from the disclosed system may provide private access for site monitoring, public access for marketing and promotion. The images also generate high definition cinematic panoramas, and high definition archives. The video may generate HD time-lapse movies. Preferably, the disclosed camera system can auto-generate 360° panoramas having over 1000 or more megapixels. Another feature is live streaming video preview featuring user controls and multiple presets. The disclosed camera system may take, and share, on-demand snapshots. The disclosed system also is capable of capturing high-definition (HD) quality 1080p or 720p video clips on demand and uploading this content for archival purposes.

The all-weather capabilities are enhanced by a lens wiper to ensure clear images. The disclosed camera system is built into in a corrosion-resistant black powder coated enclosure housing having a thermostatically regulated heater and fan. Control and operation processes are based on fast, dependable, solid state LINUX operating system and associated software.

The disclosed camera system also may include a solar power system that allows the system to be fully autonomous. The solar power system may be remotely monitored and be equipped with automatic diagnostics as well as automatic shut-down and recovery systems. The solar power system includes a circuit breaker and fuse protection and is also equipped with lightning suppression so as to not potentially harm other components within the disclosed system.

A method for capturing an image using an all-weather camera system also is disclosed. The method includes moving a camera to a pre-defined location. The method also includes performing a zoom operation using the camera. The method also includes capturing an image using the camera according to control commands received from a device server. The method also includes uploading the image to a storage device or to an Internet protocol (IP) addressable device.

A method for executing a panorama process using an all-weather camera system also is disclosed. The method includes acquiring a calibration image. The method also includes setting exposure constraints. The method also includes initiating an image capture sequence according to the exposure constraints and position sequence information using a camera. The method also includes processing at least one image acquired in the image capture sequence using image stitching and blending.

A method for executing a self-repair process for an all-weather camera system also is disclosed. The method includes monitoring components within the camera system. The method also includes identifying an error condition for a component. The method also includes displaying a code using a LED indicator. The method also includes transmitting diagnostic data from the camera system.

A method for executing a self-repair process during a loss of connection to a network from an all-weather camera system also is disclosed. The method includes monitoring a network connector within the camera system. The method also includes identifying a loss of connection to the network. The method also includes archiving at least one image to a data storage device on the camera system. The method also includes restoring the archived image over the network when the connection is re-established.

### BRIEF DESCRIPTION OF THE DRAWINGS

The accompanying drawings are included to provide further understanding of the disclosed embodiments and constitute a part of the specification. The drawings listed below illustrate embodiments of the claimed invention and, together with the description, serve to explain the principles of the invention, as disclosed by the claims and their equivalents.

FIG. 1 illustrates a camera system mounted on a base according to the disclosed embodiments.

FIG. 2A illustrates a side view of components within the camera system according to the disclosed embodiments.

FIG. 2B illustrates a top view of components within the camera system according to the disclosed embodiments.

FIG. 2C illustrates another side view of components within the camera system according to the disclosed embodiments.

FIG. 2D illustrates an exploded perspective of view of components within the camera system having a zoom control assembly according the disclosed embodiments.

FIG. 2E illustrates a side view of components with the camera system having the zoom control assembly according to the disclosed embodiments.

FIG. 2F illustrates a top view of components within the camera system having the zoom control assembly according to the disclosed embodiments.

FIG. 2G illustrates another side view of components within the camera system having the zoom control assembly according to the disclosed embodiments.

FIG. 3 illustrates a flowchart for a live imaging process according to the disclosed embodiments.

FIG. 4 illustrates a flowchart for an archiving process according to the disclosed embodiments.

FIG. 5 illustrates a flowchart for a panorama process according to the disclosed embodiments.

FIG. 6 illustrates a flowchart for a live video process according to the disclose embodiments.

FIG. 7 illustrates a flowchart for a self-repair process for the camera system according to the disclosed embodiments.

### DETAILED DESCRIPTION

Aspects of the invention are disclosed in the accompanying description. Alternate embodiments of the present invention and their equivalents are illustrated without parting from the spirit or scope of the present invention. It should be noted that like elements disclosed below are indicated by like reference numerals and the drawings.

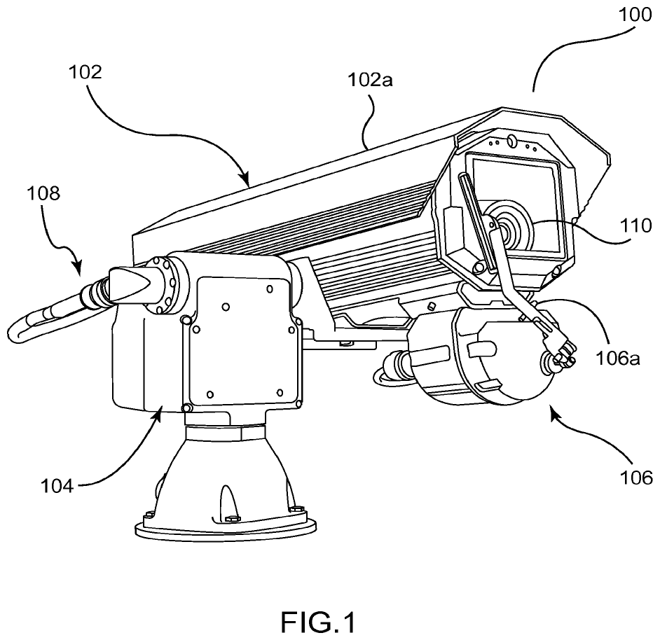

FIG. 1 depicts a camera system 100 according to the disclosed embodiments. Camera system 100 preferably is a conventional megapixel high-definition camera and lens assembly comprising an APS-C format complimentary metal-oxide-semiconductor (CMOS) image sensor. Camera system 100 includes an extending focal length lens as is known in the art, and discussed in detail below. Other image sensors may be incorporated into camera system 100 with dimensions known to those skilled in the art.

Camera system 100 is a conventional camera capable of capturing images having a resolution of about 4928 by 3264 pixels, or 16 megapixels, with panoramic resolutions of 1 gigapixel and higher. Camera system 100 also may provide images having resolutions starting at 15 megapixels and higher. Other resolution values may be implemented and higher resolutions used as capabilities evolve.

Camera system 100 includes a lens system 220 having zoom capability. The zoom capability may be based on lens selection. For example, camera system 100 may use a lens system with a zoom capability of 18 millimeters to 300 millimeters and a capability of being mechanically controlled to provide a three times (3×) optical zoom. Camera system 100, however, is not limited to these parameters, and may use a lens system of any desired zoom capability. As is known in the art, the zoom level of the lens system may be adjusted by varying the distance of the lens from the image sensor.

Camera system 100 also provides video compression of images captured during operations. Camera system 100 may incorporate audio-video interleave (AVI), QUICKTIME™ (MOV), MPEG or other file formats. In some embodiments, the AVI files may contain both audio and video data as well as support multiple streams of audio-video. Camera system 100 also may incorporate automatic features such as ISO film speed, shutter, white balance and focus high dynamic range imaging, as well as creative effects such as architectural miniature, artistic color, sketch, cinematic black and white and the like.

Camera system 100 comprises camera housing 102. Preferably, camera housing 102 includes a sun shield 102a, as shown in FIG. 1. Camera housing 102 may be comprised of aluminum and epoxy powdered coated black material. The body of camera system 100 may be constructed from extruded aluminum and die-cast aluminum cover plates. Camera housing 102 is weather-proof standard IP 66/IP 67 corrosion/resistant. The weather-proof feature of camera system 100 is maintained by gaskets between the cover plates and three cable glands, or similar elements, preventing water and dust from entering the camera housing 102.

Camera system 100 may operate in temperatures ranging preferably from about negative 30° Fahrenheit to about 130° Fahrenheit, or negative 34° Celsius to about 54° Celsius. Other dimensions and ranges may be utilized depending environmental factors and desired capabilities.

Pan/tilt unit 104, or otherwise known as precision robotic pan/tilt base, attaches itself to camera housing 102 as shown in FIG. 1. Pan/tilt base 104 is a high-performance outdoor pan/tilt assembly designed to provide steady images in windy environments. Pan/tilt base 104 may have a pan range of 360° continuous. In other words, pan/tilt base 104 can move in any direction. Pan/tilt base 104 also may have a tilt range of +90° to −90° from level. Pan/tilt base 104 may incorporate other dimensions and capabilities as needed. Pan/tilt base 104 may incorporate a step motor in moving camera system 100 to desired positions.

Camera system 100 may also include remotely controlled wiper and washer kit 106. Window wiper kit 106 includes a wiper 106a and a remote power washer having a remote or time actuation. Window wiper kit 106, therefore, may operate on command or periodically as desired. Window wiper kit 106 preferably may have cleaning fluid reservoir with sufficient capacity to operate for long periods of time, as well as a remote low fluid alert to indicate the need to replace cleaning fluid. Window wiper kit 106 moves water, debris, dirt, and the like from enclosure window 110 so that camera system 100 captures clear images. Preferably, window wiper kit 106 is located underneath camera housing 102, opposite the front edge of sun shield 102a. This placement protects window wiper kit 106 from wind and rain.

Camera system 100 also includes network connectors 108. Connectors 108 may be hard wired or wireless connectors. Connectors 108 send and receive signals from a network to camera system 100. Connectors 108 also are preferably all-weather as well.

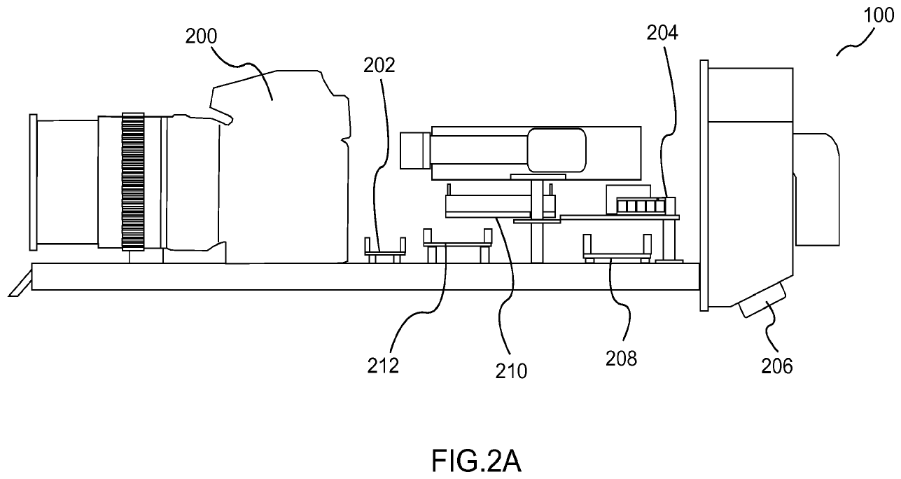

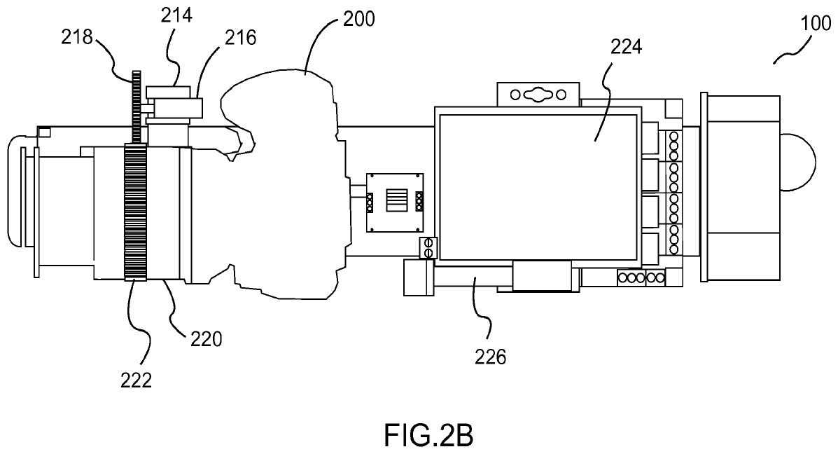

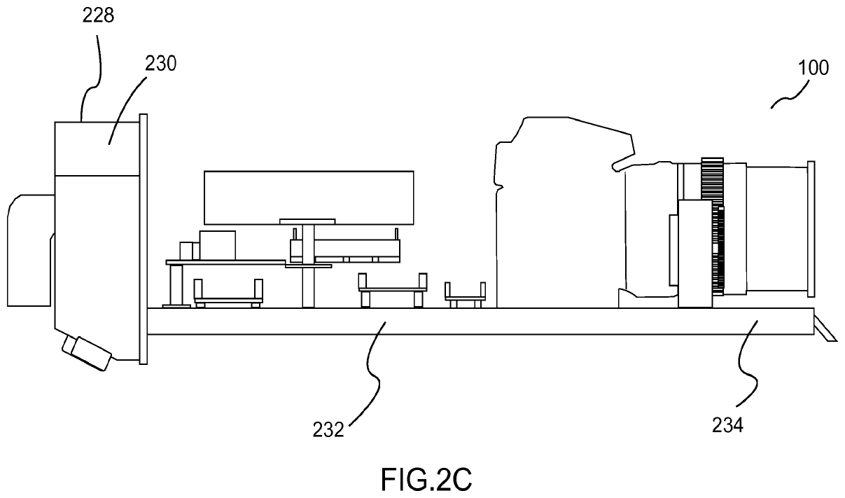

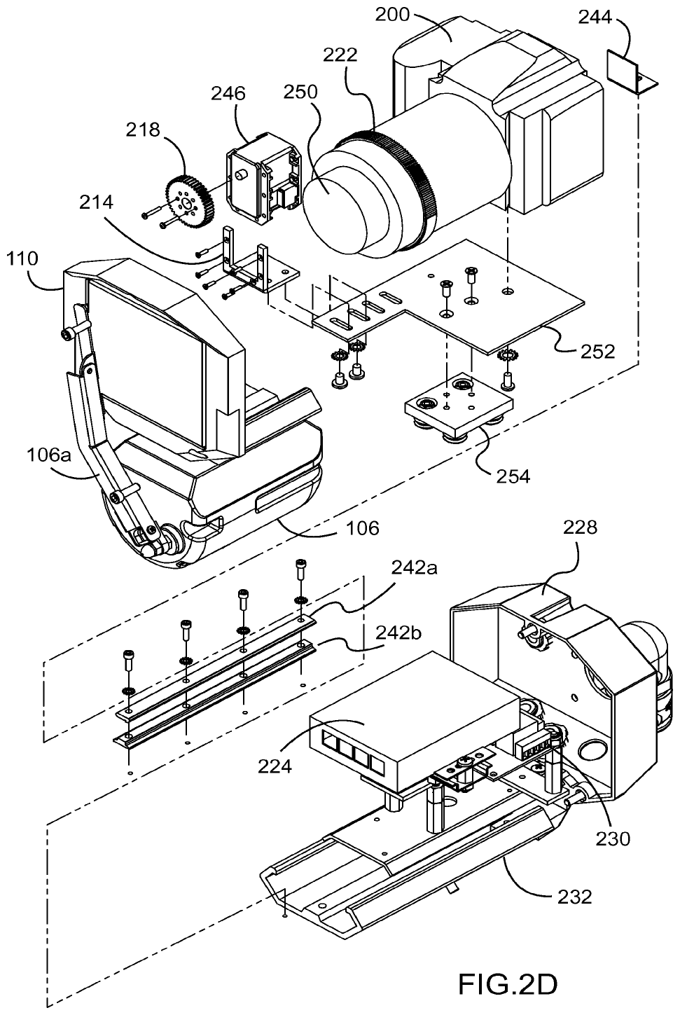

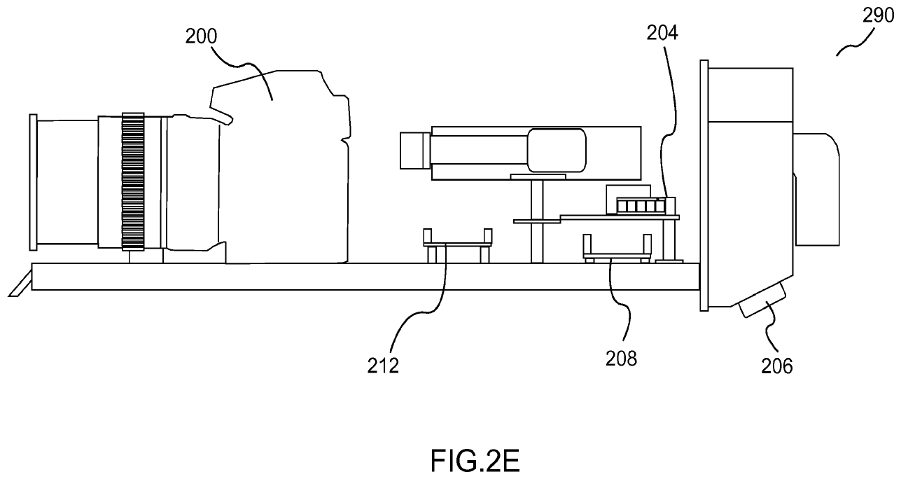

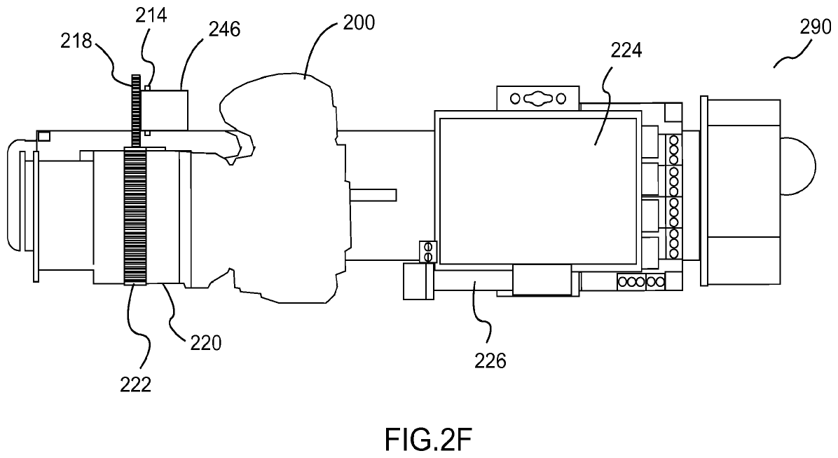

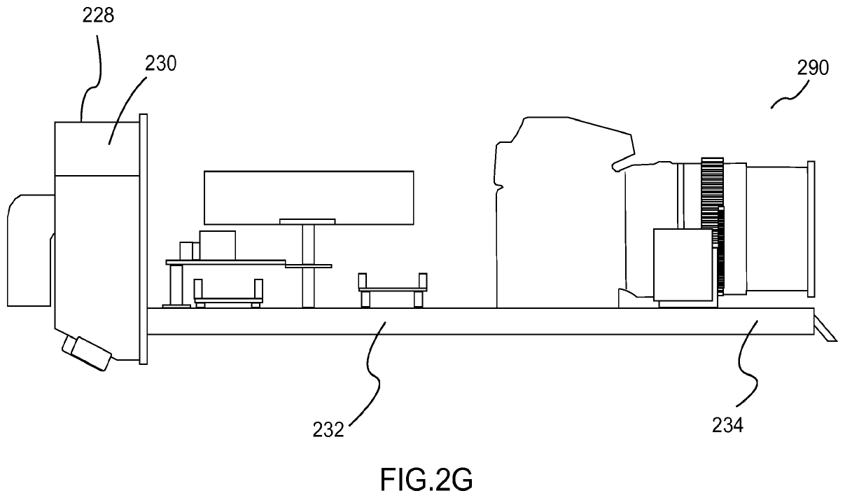

FIGS. 2A-C depict camera system 100 and the components therein according to the disclosed embodiments. FIG. 2A depicts a side view of the components within camera system 100. FIG. 2B depicts a top view of the components within camera system 100. FIG. 2C depicts an opposite side view of the components within camera system 100. These components are located primarily within camera housing 102 and protected by sun shield 102a shown in FIG. 1.

The components disclosed below may reside within camera housing and on camera sled 232. A heater 234 may be located under camera sled 232 to keep camera system 100 functional in cold conditions and to prevent ice buildup. Camera 200 is located on camera sled 232 at the front of camera system 100. Camera 200 may be electronically coupled to servomotor control board 202 and relay board 204. Servomotor control board 202 may not be implemented in some embodiments, but is shown here for illustration. Thus, the disclosed embodiments provide a platform for the camera and lens that may be mounted or placed in a variety of locations.

A multi-colored LED status indicator control board 212 is connected to multi-colored LED status indicator 206. Status indicator 206 may receive commands from control board 212 to provide visual information to an operator of the status of camera system 100. Should any component of camera system 100 fail, then status indicator 206 provides an alert, preferably visible outside the camera housing. Thus, should camera system 100 be unable to transmit, the operator may tell from a distance that the camera system needs maintenance upon seeing the LED indicator.

Camera 200 is also coupled to camera/servo power supply 210. If servomotor control board 202 is not implemented, then camera/servo power supply may be removed in certain embodiments if not needed. Camera/servo power supply 210 provides an operation power of 7.4 volts DC. Camera system 100 may have 230 volts AC available. Housing fan and heater thermostat board 208 may track temperatures and conditions of camera system 100 and activates heater 234 accordingly.

As disclosed in greater detail below, servomotor control board 202 may provide zoom instructions to camera 200. In this configuration, a remote controlled servomotor 216 is attached to camera 200. Servomotor 216 is secured by servomotor mounting bracket 214 to fix it to camera sled 232. Instructions are received to have zoom lens 220 adjust itself using gear 218 and gear ring 222 fixed to zoom lens 220. These instructions may be sent by LINUX device server 224 via RS485 communications. Thus, camera system 100 may zoom in and out as desired upon receipt of remote control or programmed instructions from device server 224.

Using servomotor 216, gear 218 rotates to move gear ring 222, which, in turn, moves zoom lens 220 to capture images. Using this zoom capability, multiple images may be captured to generate a gigapixel image. Multiple images can be captured because camera system 100 has the ability to use a zoom function on lens assembly 220 to extend the separation of lens 250 from camera body 200 into higher focal lengths. This results in images with increasing resolution. Commands may be received to perform these operations through connectors 108.

Camera system 100 also includes device server 224 and image storage device 226. Device server 224 may store software programs and instructions to operate components within camera system 100. The functionality of these programs is disclosed in greater detail below. The storage devices receive data in the form of images from camera 200. In the event of a network connection loss, image storage device 226 saves the captured images. Once a connection is reestablished, the images are automatically re-populated over the network to remote storage. These processes are disclosed in greater detail below.

Camera system 100 also includes rear 228 of camera housing 102. A fan 230 may be located in rear 228. Fan 230 may cool down camera 200 as well as device server 224 and image storage device 226. This feature prevents overheating of the components within camera system 100. Camera system 100 may be configured to turn on fan 230 at a specified temperature. This temperature may be detected by a sensor, or using heater thermostat board 208. Further, rear 228 supports camera sled 232.

FIGS. 2D-G depict a camera system 290 having a zoom control assembly according to the disclosed embodiments. The zoom control assembly is configured to move camera 200 when performing zoom operations. Lens 250 of zoom lens assembly 220 is fixed in place relative to camera housing 102, specifically the enclosure window 110. Lens 250 does not move to zoom in for an image capture. The components of the zoom control assembly are disclosed below.

Camera system 290 is similar to camera system 100, and performs the same functions and operations as camera system 100. Components shown in FIGS. 2D-G having the same reference numerals as those disclosed above are similar to the components shown in FIGS. 2A-C, and may perform the same operations. For clarity, their descriptions are not repeated.

Camera system 290 includes zoom control assembly that allows camera 200 to move within camera housing 102. The zoom control assembly includes a track rail guide assembly, which is mounted to camera sled 232. The track rail guide assembly comprises linear track rail 242a and track support 242b. Linear track rail 242a may slide along track support 242b.

The zoom control assembly also includes a bracket, or lock guide, 244 located against the rear of camera 200. Lock guide 244 may be attached to linear track rail 242a, and moves along with the guide as camera 200 moves during zoom operations. Lock guide 244 stops movement backward by camera 200 so. that it does not collide with components in the rear of camera system 290, such as device server 224. Lock guide 244 also may help keep camera 200 in place.

Linear track rail 242a slides backward due to the motion of robotic actuator 246 rotating gear ring 222. The robotic actuator also may be known as a robotic servomotor. Robotic actuator 246 moves to rotate gear ring 222. As gear ring 222 rotates, camera 200 may increase focal length for capturing an image.

Lens 250 remains fixed in place relative to camera housing 102, proximate to enclosure window 110 and does not move. The rotation of gear 218 of robotic actuator 246 against gear ring 222 normally would cause the extension of lens 220 with respect to camera 200, moving lens 250 away from camera 200. With lens 250 fixed in place, the rotation of gear ring 222 instead will cause zoom lens 220 to extend, causing camera 200 to move along the track rail guide assembly, away from lens 250.

Camera 200 is mounted on camera mount sled 252, which is connected to track rail guide 242 by linear carriage 254. Linear carriage 254 engages linear track rail 242a using rollers on the bottom to move in a forward or backward direction. This feature allows movement of camera 200 without any direct contact with the track rail guide assembly. Camera mount sled 252 provides a stable platform as well.

For some camera and lens assemblies, movement of camera 200 on camera mount sled 252 may cause the extension of lens 220 with respect to camera 200 without the need for gear ring 222 and gear 218. Camera mount sled 252 may be driven by a separate actuator.

Using these components, the zoom control assembly may eliminate the need for components used in the servomotor embodiment. For example, a servomotor control board and separate servomotor power supply may not be needed. Robotic actuator 246 is connected directly to device server 224. Robotic actuator 246 also works on camera housing 102 power, such as 12 volts direct current (VDC).

Zoom capabilities are limited to the overall length of the camera housing and the length of zoom lens 220, as the camera lens 250 is fixed in position near the enclosure window, and the zoom is caused by movement of the camera body 200 away from the lens 250. In existing systems, limits exist on how far the lens can be from the cover, and if the camera system can still be effective. These limits do not apply to camera system 290. Camera 200 can move within the housing, which allows for the ability to extend focal length to capture an image. Camera housing 102 may be extended in length to allow for greater extension of lens 220 from camera body 200. A greater number of more detailed images may be captured for a better quality panoramic image. Camera system 290 may acquire thousands of images to interleave together for such a preferred resulting composite image.

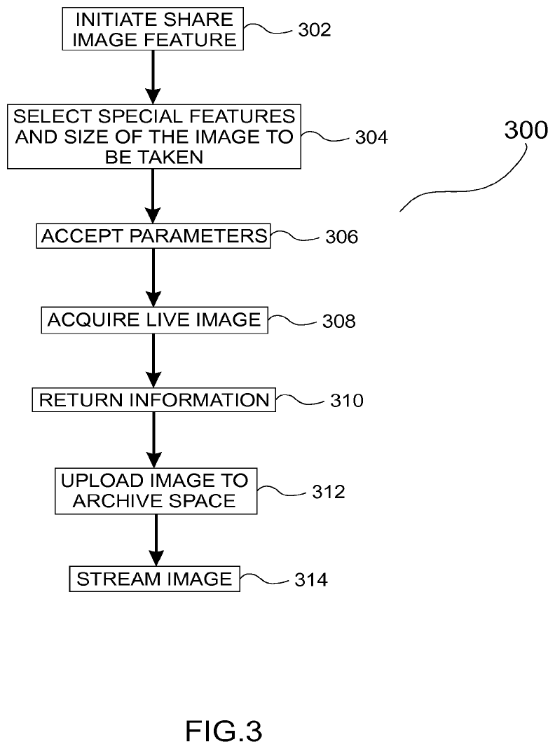

FIGS. 3-7 show flowcharts for various control processes executed with camera system 100 that may be timed or special event driven. Although camera system 100 is referenced below, camera system 290 also is applicable to perform the processes. The processes may control components of the applicable camera system to perform specific actions. Where applicable, FIGS. 3-7 prefer back to the components of camera system 100 or camera system 290. The processes, however, are not limited structurally to the components of camera systems 100 and 290, and may include additional features and configurations.

The functionality and steps disclosed below may be performed using instructions stored within device server 224, or provided to camera system 100 from a remote storage via a network accessible by connectors 108. These instructions may be executed to configure the components disclosed above into a special purpose camera system to capture and store images/data.

FIG. 3 depicts a flowchart 300 for live image processing a camera system 100 according to the disclosed embodiments. Live image processing may refer to capturing an image in real time upon request. Step 302 executes by initiating the share image feature within camera system 100. A user, or client, may initiate the share image feature. Step 304 executes by selecting from the list of special features. The size of the image to be taken also may be selected by the user in this step.

Step 306 executes by accepting the parameters corresponding to the selected special features and size event image by camera system 100. Step 308 executes by acquiring the live image by camera 200. Step 310 executes by returning information to a client browser regarding the success or failure of the image capture. For example, the user may be alerted via a web browser that a successful image was taken according to their request.

Step 312 executes by uploading the acquired image to archive space corresponding to the user over a network. Thus, the captured image may be sent via connectors 108 to the user over a network, such as an internet connection. Step 314 executes by streaming the image to the client browser from the network. In other words, the image is uploaded to archive space associated with the user on a dedicated network. This dedicated network may be a private network and the archive space only accessible by the user. The image is then streamed to a web browser for the user from the dedicated network.

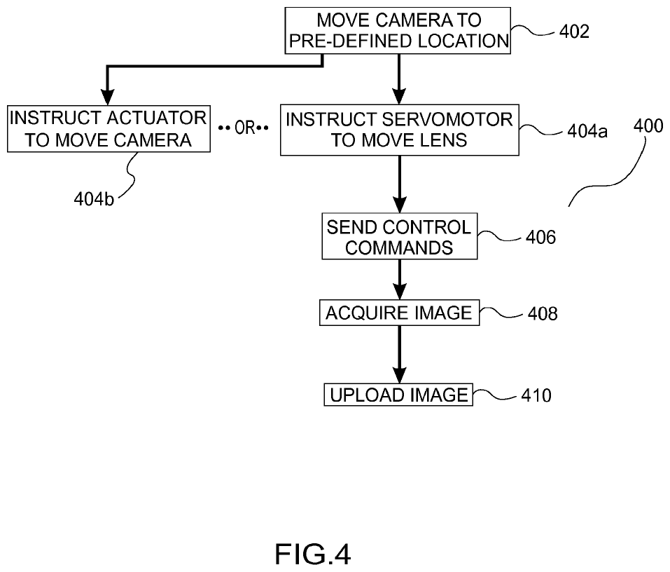

FIG. 4 depicts a flowchart 400 for an archiving process of camera system 100 according to the disclosed embodiments. The archiving process may relate to capturing or acquiring an image at a predetermined time or according to a predetermined schedule. Step 402 executes by position camera system 100 to a pre-defined orientation. Pan/tilt unit 104 may position camera housing 102 to this orientation. In some embodiments, camera 200 may be moved within camera housing 102 to perform zoom operations.

Steps 404a and 404b are executed after step 402. The step executed depends on the configuration of camera system 100. Step 404a executes by instructing zoom, or servo, motor 216 to move zoom lens 220 to a pre-defined zoom position according to the embodiments shown in FIGS. 2A-C. This instruction may be issued by device server 224 and received as a signal from zoom motor control board 202. Step 404b executes by instructing robotic actuator 246 to move camera 200 according to the embodiments shown in FIGS. 2D-G. An instruction may be received directly at robotic actuator 246 from device server 224.

Steps 404a or 404b allow camera 200 to move into position to take capture an image at a discrete location. Thus, camera system 100 or 290 may move to specific locations and zoom in to capture these images. Step 406 executes by sending control commands to camera system 100, and more specifically, to camera 200. Control commands include auto-focus, exposure, and other defined control commands.

Step 408 executes by acquiring the image using camera 200. The image is acquired according to a control command specified above. These commands may be stored in device server 224. Step 410 executes by uploading the acquired image to server 224 for archival. Thus, an image may be acquired at a set time according to set parameters as instructed by server 224.

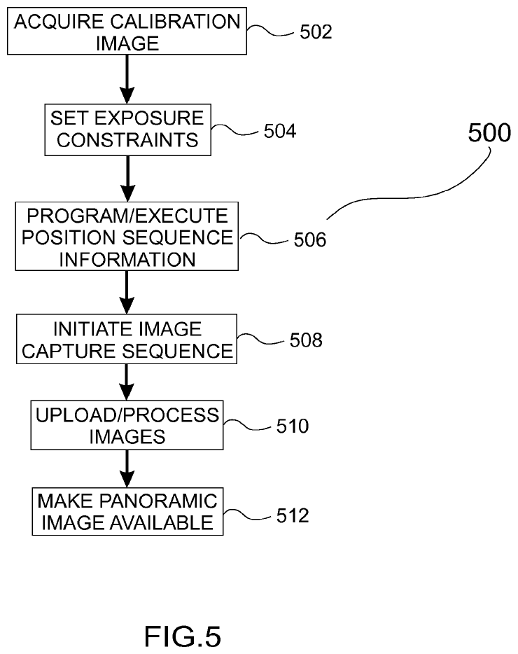

FIG. 5 depicts a flowchart 500 for performing a panorama process using camera system 100 according to the disclosed embodiments. A panorama image may be a collection of 100s or 1000s of smaller images taken in precise locations that are then weaved together to form a large image. Examples include skylines, stadiums or nature images. The disclosed embodiments facilitate better panoramic images because the disclosed camera system takes higher definition images than conventional cameras. Using the zoom capabilities disclose above, the disclosed camera system takes a more precise and smaller image that is used in the panoramic image. Smaller and more precise images results in the use of 1000s of images, each clearer and more defined than conventional camera images, for the overall image.

Step 502 executes by acquiring a calibration image of a pre-defined area. Device server 224 may provide instructions to camera 200 of an area of interest for the panorama. Camera 200 takes the calibration image. Step 504 executes by automatically setting exposure constraints for acquiring the image. Device server 224 may receive instructions over the connected network for taking the panoramic image. For example, the images should not be taken if light is too high or low, or if too much cloudy. These constraints also may be set within camera system 100 and stored in device server 224.

Step 506 executes by programming or executing position sequence information. The position sequence information is sent to pan/tilt base unit 104 and zoom motor control board 202. If camera system 290 is used, then zoom motor control board is not used. Position information may be sent from device server 224 to robotic actuator 246. This information may be used to move camera system 100 to a specific location and zoom in on a target area as requested.

Step 508 executes by initiating an image capture sequence. The image capture sequence may start from top left to bottom right. Exposures are based on the calibration image or, alternatively, may use the setup when camera system 100 was initially configured. Other sequences may be used to capture the images. The capture of an image may be subject to the constraints received or specified above. The sequence may move camera system 100 in a pattern to capture images bordering each other. The initial image, for example, may be taken in the lowest right hand corner of the calibration image. Camera 200 may proceed left until coming to the left side border of the image, and then move upwards. Other embodiments may start in other locations and move in a different pattern. The pattern and instructions for executing the functions to achieve it may be stored on device server 224.

Step 510 executes by uploading or processing the captured images to servers over a network. The images are processed using automated image stitching and blending processes. Images may be stored on image storage device 226, and then placed on the network as a bundle as opposed to streaming the images. For example, the panoramic image may be generated within camera system 100 and sent as a file over the network. Alternatively, the images may be streamed from camera system 100 to another processing device that performs the image stitching and blending processes.

Thus, the applicable camera system 100 or 290 may position camera 200 and zoom to a location to capture an image. Camera 200 is moved to multiple positions while zooming in to compile a large number of images. Preferably, the number of images is in the 100s or even in the 1000s. A large number of images provides a better quality panoramic image. Such a large number results from the configuration of camera system 100 or 290.

Step 512 executes by making the panoramic image available to a user using a panorama player. The panorama player utilizes image tiling to efficiently stream only the viewed high-resolution parts of the panorama image. This feature conserves bandwidth by not processing unneeded images. Thus, the panoramic image may be made available over a web-based network to the user.

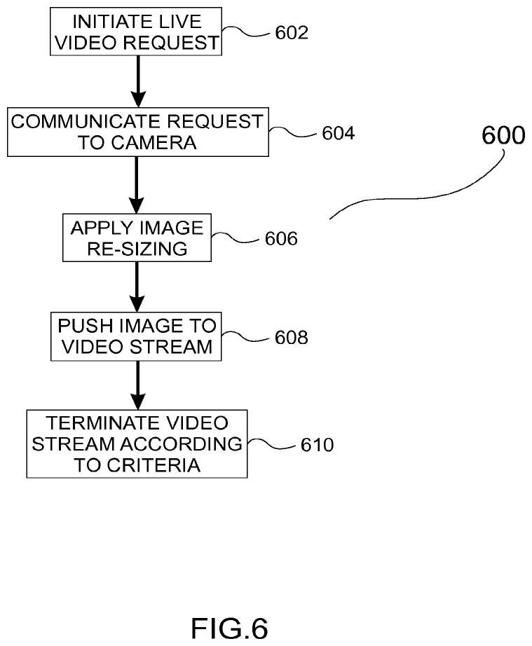

FIG. 6 depicts a flowchart 600 for live video processing by camera system 100 according to the disclosed embodiments. Step 602 executes by initiating a live video request from the network. The request may be received via network connectors 108. Preferably, the network is a wireless network. Step 604 executes by communicating this request to camera 200. Device server 224 may relay the request to camera 200. A live image is requested from the image sensor at a minimum of three frames per second (fps).

Step 606 executes by applying image-resizing if requested, to images. Step 608 executes by pushing the image into a video stream. Captured images by camera 200 are placed into a video stream directly to a user. Although camera 200 captures images individually, camera system 100 combines these images according to known formats to provide a video stream. Alternatively, the images may be stored on image storage device 226 for a period before transmitting from camera system 100.

Step 610 executes by terminating the video stream according to set criteria. These criteria may relate to overheating conditions within camera system 100 or if a specified timeout time has been reached. For example, if an overheat condition is sensed within camera system 100, then any video stream may be terminated to prevent damage to camera system 100. As camera 200 acquires images, it may overheat, especially in hot conditions. Thus, camera system 100 should be shut down before any further damage is done.

Alternatively, the live video stream may be terminated after a certain period, such as 15 minutes, has elapsed. This time period prevents the unneeded utilization of bandwidth over the network or a power drain occurring due to a long and continuous video stream. A user may keep the connection open by sending instructions. Once terminated, live video has to be requested again in order to commence streaming operations. This feature eliminates video connections inadvertently being left open by the user.

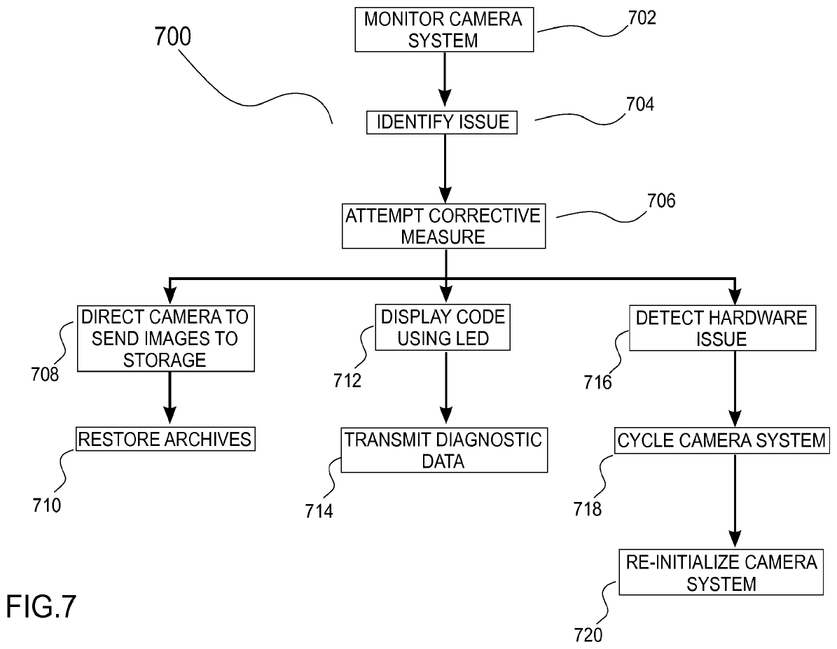

FIG. 7 depicts a self-repair process for camera system 100 according to the disclosed embodiments. In some instances, camera system 100 identifies an error condition and takes action. This action may be known as a self-repair process. Afterwards, information may be gathered over the network on the error condition and steps taken to correct it.

Step 702 executes by monitoring camera system 100. The process monitors system vitals such as network loss, slow internet speeds, pant/tile unit (PTU) failure, camera failure, backup memory failure, solar panel data, UPS data and the like. The disclosed process also may monitor window wiper kit 106 for low fluid or errors resulting from obstruction during movement of pan/tilt base unit 104.

Step 704 executes by identifying the issue causing the error condition. The error condition may be related to the programs loaded onto device server 224 to perform operations. Device server 224 may instruct a component to perform an operation, and it does not. Alternatively, device server 224 crashes while running a program. Other error conditions may apply. Step 706 executes by attempting corrective measures, as disclosed below. These corrective measures may be executed separately or in conjunction with each other.

Step 708 executes by directing camera 200 to send images to image storage device 226 in the event of an internet or network connection loss. Internet loss will direct camera 200 to send images to on-board storage 226. Upon restoration of the internet or network connection, step 710 executes by restoring the archives of saved images. Camera system 100 may automatically scan the list of images ready for restoration to perform a restore process in between normal archive tasks so as to not disrupt newer archives being created after reconnection. Thus, images are not lost during a lack of connection with the network.

Step 712 executes by displaying a code using LED status indicator 206. Thus, an error code or codes may be displayed using diagnostic LED status indicator 206 located in rear 228 of camera housing 102. LED status indicator 206 may be visible to a user at a distance from camera system 100. LED status indicator 206 may have more than one LED as well. For example, a plurality of LEDs may display different colors during “on” states so that each color represents a different status for camera system 100. Step 714 executes by transmitting the diagnostic data over the network for trouble shooting, if needed.

Step 716 executes by detecting a hardware issue within camera system 100. In this scenario, internet connection is not lost and a problem results from one of the components within camera system 100. Step 718 executes by cycling through the components of camera system 100. Camera system 100 power cycles through the components within using on-board relays, such as relay board 204, to identify faulty components. Further, device server 224 may monitor components within camera system 100 for any of the conditions disclosed above. Sensors and other components may be utilized by device server 224 to receive information about the status of components within camera system 100. Step 720 executes by re-initializing camera system 100.

Thus, camera system 100 provides a capability of viewing actual live video under any conditions and in an around the clock format. Camera system 100 may use picture in picture to view live video, while viewing high definition images. Robotic pan/tilt and zoom control of camera system 100 allows it to move the camera to different locations and different configurations.

Thus, the disclosed embodiments related to a camera system able to operation under severe and remote conditions. The camera system 100 may be placed on top of buildings, monuments and other structures, even those not readily accessible to a user, and provide images and video over a network connection. The camera system includes an assembly to facilitate zooming operations with a megapixel camera. In some embodiments, the camera itself moves backwards to zoom while its lens is held in place. This feature reduces the limits placed on zoom capabilities by moving the lens.

In the event of a disruption of services, the camera system 100 may store images and data at the camera system 100 until service is re-established. Thus, no data is lost during a disconnect condition from a network. The programs and software may reside at the camera system 100 as well, so that, even off-line, the camera system 100 can continue operations.

The disclosed embodiments may be supported and executed on a camera platform that has access to a network. The platform may support software and executable programs to provide the functionality disclosed above, using components such as device server 224. For instance, the software may be deployed. Any software embodying the disclosed functions and processes may be deployed by manually loading directly to the client, server and proxy computers via loading a storage medium such a CD, DVD, flash memory, chip, downloadable program and the like. The software also may be automatically or semi-automatically deployed into the camera system by sending the process software to a central server or a group of central servers. The software is downloaded into the client computers that execute the programs and instructions associated with the software in conjunction with the disclosed camera system.

As will be appreciated by one skilled in the art, the present invention may be embodied as a camera system, method or computer program product installed on the camera system. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized to enable device server 224 or image storage device 226. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory, such as device server 224.

In the context of this specification, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages.

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of camera systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures, and may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Embodiments may be implemented as a computer process, a computing system or as an article of manufacture such as a computer program product of computer readable media. The computer program product may be a computer storage medium readable by a computer system and encoding a computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. The embodiment was chosen and described in order to best explain the principles of the invention and the practical application, and to enable others of ordinary skill in the art to understand the invention for embodiments with various modifications as are suited to the particular use contemplated.

While certain novel features of the present invention have been shown and described, it will be understood that various omissions, substitutions and changes in the forms and details of the camera system illustrated and in its operation can be made by those skilled in the art without departing from the spirit of the invention. It is intended that the present invention covers these modifications and variations disclosed above provided that such modifications and variations come within the scope of any claims and their equivalents.

I claim:

1. An all-weather, remote camera system capable of installation in a fixed outdoor location, the camera system comprising:
a weather-proof camera housing comprising an enclosure window;
a camera enclosed by the weather-proof camera housing, the camera comprised of a camera body and a conventional camera lens assembly, where the camera lens assembly is comprised of a camera lens and a lens body, and where the camera lens is maintained at a fixed location relative to the enclosure window, and the camera body is free to move within the weather-proof camera housing;
a camera sled on which the camera body is mounted;
a zoom control assembly mounted on the camera sled, said zoom control assembly comprised of a track rail guide assembly mounted to the camera sled, said track rail guide assembly comprises a linear track rail, a track support on which the linear track rail slides and a linear carriage, said camera sled connected to the track rail guide assembly by the linear carriage, said linear carriage configured to move in a forward or a backward direction by engaging the linear track rail using a plurality of rollers on a bottom of the linear carriage, wherein the linear carriage allows movement of the camera body mounted on the camera sled without any direct contact with the track rail guide assembly, wherein said camera sled, track rail guide assembly and linear carriage are enclosed by the weather-proof camera housing;
a device server that includes a local processor that executes software programs and instructions, wherein the device server is in communication with the camera and instructs the camera to focus the camera while the camera lens is maintained at the fixed distance from the enclosure window and capture an image and wherein the device server is located within the weather-proof camera housing;
a robotic actuator mounted on the camera sled and in communication with the device server, wherein the device server executes software programs and instructions to instruct the robotic actuator to perform a zoom operation using the zoom control assembly that moves the camera body mounted on the camera sled back and forth on the track rail guide assembly within the weather-proof camera housing while the camera lens is maintained at the fixed distance from the enclosure window during the zoom operation, and where the weather-proof camera housing is not moved in a direction toward or away from a target during the zoom operation; and
a storage device located within the weather-proof camera housing to store the image and a network connector to establish a connection with a network to transmit the image to a remote Internet protocol (IP) addressable device.

2. The camera system of claim 1, wherein the zoom control assembly mounted on the camera sled further includes a bracket to hold the camera lens at the fixed distance from the enclosure window during the zoom operation.

3. The camera system of claim 1, wherein the robotic actuator is engaged with a gear ring on the lens body, and the robotic actuator causes the camera body and sled to move by rotating the gear ring on the lens body.

4. The camera system of claim 1, further comprising a heater activated by a thermostat board.

5. The camera system of claim 1, wherein the device server executes software programs and instructions to automatically store the image on the storage device when the connection with the network is lost and to automatically transmit the image over the network to the Internet protocol (IP) addressable device when the connection with the network is restored.

6. The camera system of claim 1, wherein during the zoom operation the enclosure window and camera lens remain at a fixed distance from a target area.

7. The camera system of claim 1, further comprising a LED status indicator.

8. An all-weather, remote camera system comprising:
a weather-proof camera housing having a front and a rear, the weather-proof camera housing engaged to a pan/tilt base and having an enclosure window in the front of the weather-proof camera housing;
a camera comprising a camera body mounted on a camera sled and a conventional camera lens assembly, the camera lens assembly comprised of a camera lens and a lens body, the camera enclosed by the weather-proof camera housing, said camera body configured to move within the weather-proof camera housing while said camera lens is maintained at a fixed distance from the enclosure window, wherein a zoom control assembly is mounted to said camera, said zoom control assembly comprised of a track rail guide assembly mounted to the camera sled, said track rail guide assembly comprises a linear track rail, a track support on which the linear track rail slides, and a linear carriage, said camera sled connected to the track rail guide assembly by the linear carriage, said linear carriage configured to move in a forward or a backward direction by engaging the linear track rail using a plurality of rollers on a bottom of the linear carriage, wherein the linear carriage allows movement of the camera body mounted on the camera sled without any direct contact with the track rail guide assembly, wherein said camera sled, track rail guide assembly and linear carriage are enclosed by the weather-proof camera housing;
a storage device enclosed within the weather-proof camera housing to store an image captured by the camera;
a device server enclosed within the weather-proof camera housing that includes a local processor that executes software programs and instructions, wherein the device server is in communication with the camera and instructs the camera to focus the camera while the camera lens is maintained at the fixed distance from the enclosure window and capture an image and wherein the device server is located within the weather-proof camera housing;
a robotic actuator mounted on the camera sled and in communication with the device server, said robotic actuator engaged with a gear ring on the lens body, wherein the device server executes software programs and instructions to instruct the robotic actuator to perform a zoom operation using the zoom control assembly that moves the camera body mounted on the camera sled back and forth on the track rail guide assembly by the robotic actuator rotating the gear ring on the lens body within the weather-proof camera housing while the camera lens is maintained at the fixed distance from the enclosure window during the zoom operation, and where the weather-proof camera housing is not moved in a direction toward or away from a target during the zoom operation; and
a network connector to establish a connection with a network to transmit the image to a remote Internet protocol (IP) addressable device.

9. The camera system of claim 8, wherein during the zoom operation the camera lens remains at a fixed distance from the target area, while the lens body extends in length.
